(19) United States
(12) Patent Application Publication
(10) Pub. No.: US 2026/0051557 A1
(43) Pub. Date: Feb. 19, 2026

(54) PRESSURE AND FLOW RELIEF STRATEGIES FOR TRACTION BATTERY THERMAL MANAGEMENT COOLANT CIRCUITS

(71) Applicant: FORD GLOBAL TECHNOLOGIES, LLC, Dearborn, MI (US)

(72) Inventors: Ronald Richard SEMEL, West Bloomfield, MI (US); James Thomas GOODEN, Canton, MI (US)

(21) Appl. No.: 18/802,182

(22) Filed: Aug. 13, 2024

(51) Int. Cl. H01M 10/63; H01M 10/613; H01M 10/625; H01M 10/6568; H01M 50/30; H01M 50/317

(52) U.S. Cl. CPC H01M 10/63; H01M 10/625; H01M 10/6568; H01M 50/317; H01M 50/394; H01M 10/613; H01M 2220/20

(57) ABSTRACT

Thermal management systems are provided for managing the thermal energy levels of a traction battery pack of an electrified vehicle. An exemplary thermal management system may include a coolant circuit for circulating a coolant through the traction battery pack. A pressure relief valve may be arranged to control a flow of a fluid through an auxiliary fluid path of the coolant circuit. For example, the pressure relief valve may control the flow of a vent byproduct released by a battery cell of the traction battery pack into the auxiliary fluid path during a battery thermal event of the traction battery pack. The vent byproduct may then be directed from the auxiliary fluid path to either atmosphere or a coolant reservoir. The system may additionally include a gas separator. The gas separator may remove entrained gases (air, vent byproducts, etc.) from the coolant during both normal operating conditions and during battery thermal events. The removed gases can be expelled to atmosphere from within the coolant reservoir.

### TECHNICAL FIELD

This disclosure relates generally to electrified vehicles, and more particularly to battery thermal management systems capable of controlling fluid flow and pressure within a coolant circuit during both normal operating operations and during battery thermal events.

### BACKGROUND

An electrified vehicle includes a traction battery pack for powering electric machines and other electrical loads of the vehicle. The traction battery pack includes a plurality of battery cells and various other battery internal components that support electric vehicle propulsion.

### SUMMARY

A thermal management system for an electrified vehicle according to an exemplary aspect of the present disclosure includes, among other things, a traction battery pack, a coolant circuit configured to circulate a coolant through the traction battery pack, an auxiliary fluid path fluidly connectable to the coolant circuit, and a pressure relief valve configured to control a flow of a vent byproduct released by a battery cell of the traction battery pack into the auxiliary fluid path during a battery thermal event of the traction battery pack.

In a further non-limiting embodiment of the foregoing thermal management system, the thermal management system is an immersion thermal management system.

In a further non-limiting embodiment of either of the foregoing thermal management systems, the pressure relief valve includes a valve member movable from a default closed position in which the vent byproduct is prevented from entering the auxiliary fluid path and a secondary actuated position in which the vent byproduct is permitted to enter the auxiliary fluid path.

In a further non-limiting embodiment of any of the foregoing thermal management systems, the valve member is configured to move from the default closed position to the secondary actuated position when a pressure of the vent byproduct received at the pressure relief valve exceeds a predefined pressure threshold.

In a further non-limiting embodiment of any of the foregoing thermal management systems, a gas separator is configured to deaerate the coolant that is circulated through the traction battery pack.

In a further non-limiting embodiment of any of the foregoing thermal management systems, a reservoir is configured to receive a gas removed from the coolant by the gas separator.

In a further non-limiting embodiment of any of the foregoing thermal management systems, the gas separator is packaged at a first location of the electrified vehicle, and the reservoir is packaged at a second location of the electrified vehicle. The second location is vertically higher than the first location.

In a further non-limiting embodiment of any of the foregoing thermal management systems, the second location is at a highest point of the coolant circuit.

In a further non-limiting embodiment of any of the foregoing thermal management systems, the gas includes a portion of the vent byproduct released by the battery cell of the traction battery pack.

In a further non-limiting embodiment of any of the foregoing thermal management systems, a heat exchanger is configured to cool the coolant prior to the coolant being returned to the traction battery pack.

In a further non-limiting embodiment of any of the foregoing thermal management systems, a check valve is arranged within the coolant circuit between the heat exchanger and the traction battery pack.

In a further non-limiting embodiment of any of the foregoing thermal management systems, the auxiliary fluid path is fluidly connected to a coolant reservoir.

In a further non-limiting embodiment of any of the foregoing thermal management systems, the auxiliary fluid path is fluidly connected to atmosphere.

In a further non-limiting embodiment of any of the foregoing thermal management systems, an accumulator is positioned either upstream or downstream from the pressure relief valve.

A thermal management system for an electrified vehicle according to another exemplary aspect of the present disclosure includes, among other things, a traction battery pack, a gas separator configured to deaerate a coolant that is circulated through the traction battery pack, a reservoir configured to receive a gas once removed from the coolant by the gas separator, and a pressure relief valve configured to control a flow of a vent byproduct released by a battery cell of the traction battery pack into an auxiliary fluid path that bypasses the gas separator during a battery thermal event of the traction battery pack.

In a further non-limiting embodiment of the foregoing thermal management system, an accumulator is positioned either upstream or downstream from the pressure relief valve.

In a further non-limiting embodiment of either of the foregoing thermal management systems, the pressure relief valve includes a valve member movable from a default closed position in which the vent byproduct is prevented from entering the auxiliary fluid path to a secondary actuated position in which the vent byproduct is permitted to enter the auxiliary fluid path.

In a further non-limiting embodiment of any of the foregoing thermal management systems, the valve member is configured to move from the default closed position to the secondary actuated position when a pressure of the vent byproduct received at the pressure relief valve exceeds a predefined pressure threshold.

In a further non-limiting embodiment of any of the foregoing thermal management systems, the auxiliary fluid path is fluidly connected to the reservoir.

In a further non-limiting embodiment of any of the foregoing thermal management systems, a check valve is located between the traction battery pack and a heat exchanger that is configured to exchange heat with the coolant.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 schematically illustrates a thermal management system for thermally managing a traction battery pack of an electrified vehicle.

FIG. 3 schematically illustrates another thermal management system for thermally managing a traction battery pack of an electrified vehicle.

FIG. 4 schematically illustrates another thermal management system for thermally managing a traction battery pack of an electrified vehicle.

FIG. 5 schematically illustrates another thermal management system for thermally managing a traction battery pack of an electrified vehicle.

FIG. 6 schematically illustrates yet another thermal management system for thermally managing a traction battery pack of an electrified vehicle.

### DETAILED DESCRIPTION

This disclosure details thermal management systems for managing the thermal energy levels of a traction battery pack of an electrified vehicle. An exemplary thermal management system may include a coolant circuit for circulating a coolant through the traction battery pack. A pressure relief valve may control a flow of a fluid through an auxiliary fluid path of the coolant circuit. For example, the pressure relief valve may be arranged to control the flow of a vent byproduct released by a battery cell of the traction battery pack into the auxiliary fluid path during a battery thermal event of the traction battery pack. The vent byproduct may then be directed from the auxiliary fluid path to either atmosphere or a coolant reservoir. The system may additionally include a gas separator. The gas separator may remove entrained gases (air, vent byproducts, etc.) from the coolant during both normal operating conditions and during battery thermal events. The removed gases can be expelled to atmosphere from within the coolant reservoir. These and other features are discussed in greater detail in the following paragraphs of this detailed description.

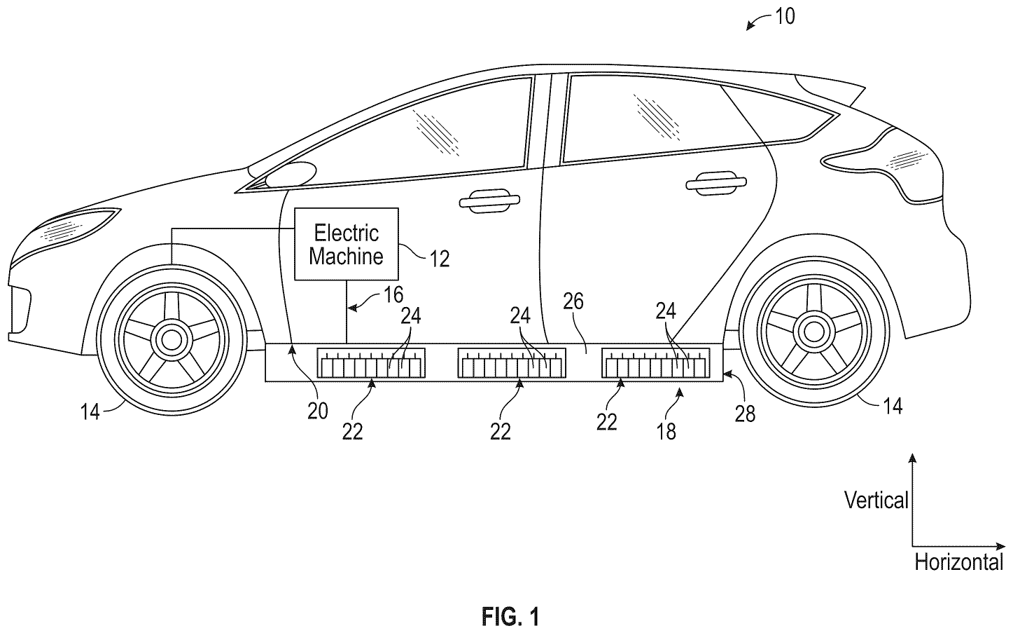

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle traction battery. The traction battery pack 18 may be a high voltage traction battery pack assembly that includes a plurality of battery cells 24 capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

The traction battery pack 18 may include one or more battery arrays 22 (e.g., battery modules or groupings of rechargeable battery cells 24) capable of outputting electrical power to power the electric machine 12 and/or other electrical loads of the electrified vehicle 10. Other types of energy storage devices and/or output devices could alternatively or additionally be used to electrically power the electrified vehicle 10.

The one or more battery arrays 22 of the traction battery pack 18 may each include a plurality of battery cells 24 that store energy for powering various electrical loads of the electrified vehicle 10. The traction battery pack 18 could employ any number of battery cells 24 within the scope of this disclosure. Accordingly, this disclosure should not be limited to the highly schematic configuration shown in FIG. 1.

In an embodiment, the battery cells 24 of each battery array 22 are lithium-ion pouch cells. However, battery cells having other geometries (cylindrical, prismatic, etc.), other chemistries (nickel-metal hydride, lead-acid, etc.), or both could alternatively be utilized within the scope of this disclosure.

The battery arrays 22 and various other battery internal components (e.g., bussed electrical center, battery electric control module, wiring, connectors, etc.) may be housed within an interior area 26 of an enclosure assembly 28. The enclosure assembly 28 may include an enclosure cover and an enclosure tray, for example. The enclosure cover may be secured (e.g., bolted, welded, adhered, etc.) to the enclosure tray to provide the interior area 26. The size, shape, and overall configuration of the enclosure assembly 28 is not intended to limit this disclosure.

Thermal energy levels within the traction battery pack 18 can periodically increase as the electrified vehicle 10 is operated. This disclosure is therefore directed to thermal management systems that are capable of managing the thermal energy levels of the traction battery pack 18 while also providing degassing and pressure alleviating functions during various thermal operating conditions of the traction battery pack 18.

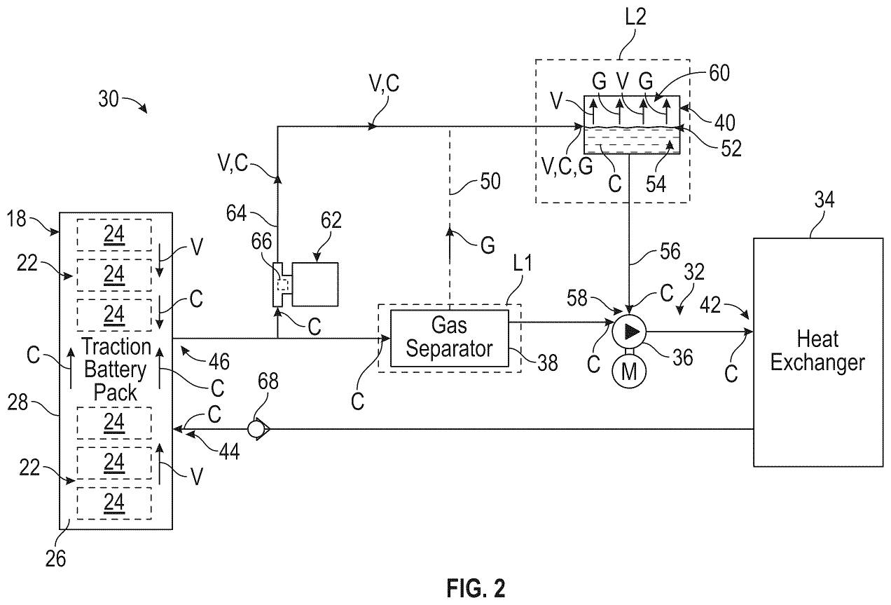

FIG. 2 schematically illustrates a thermal management system 30 that can be incorporated into an electrified vehicle, such as the electrified vehicle 10 of FIG. 1, for example, for managing the thermal loads generated by the traction battery pack 18 and/or another vehicle component(s). The thermal management system 30 can selectively communicate a coolant C through the interior area 26 of the traction battery pack 18 to remove heat from the battery cells 24 packaged inside the traction battery pack 18. Although only schematically shown in some instances, the various subcomponents of the thermal management system 30 can be fluidly interconnected by various conduits or passages such as tubes, hoses, pipes, etc.

The thermal management system 30 includes a coolant circuit 32 for circulating the coolant C to thermally manage the traction battery pack 18. In an embodiment, the coolant C is water mixed with ethylene glycol or another suitable coolant. In another embodiment, the thermal management system 30 is an immersion thermal management system and thus the coolant C can include a dielectric fluid or another type of non-conductive fluid (e.g., oil) that is designed for immersion cooling the battery cells 24 of the traction battery pack 18. Immersion cooling involves immersing portions of the traction battery pack 18, such as the battery cells 24 of the battery arrays 22, in the coolant C.

The coolant circuit 32 may include at least a heat exchanger 34, a pump 36, a gas separator 38, and a reservoir 40. The gas separator 38 and the reservoir 40 may replace the conventional degas bottle typically utilized within prior thermal management systems. Conventional degas bottles can be less effective at removing air and/or other gases from the coolant circuit 32 in immersion type thermal management systems that typically require increased coolant volumes, pressures, and flow rates.

During operation in which the coolant C is circulated through the coolant circuit 32 of the thermal management system 30, thermal energy picked up from the traction battery pack 18 may be transferred from the coolant C to ambient air outside the electrified vehicle 10 within the heat exchanger 34. In an embodiment, the heat exchanger 34 is a radiator (i.e., a fluid-to-air heat exchanger). Thus, airflow may be drawn through the heat exchanger 34 for undergoing convective heat transfer with the coolant C. The airflow can exchange heat with the coolant C as the two fluids flow across/through the heat exchanger 34. The cooled coolant C may then be returned to the traction battery pack 18 as part of a closed loop of the coolant circuit 32.

The pump 36 may operate to circulate the coolant C through the coolant circuit 32. In an embodiment, the pump 36 is located between the gas separator 38 and an inlet 42 of the heat exchanger 34. However, the pump 36 could be located elsewhere within the coolant circuit 32. The pump 36 may be an electrically powered fluid pump or another type of pump within the scope of this disclosure.

The coolant C that is pumped through the traction battery pack 18 may take on thermal energy from the battery cells 24. The coolant C may enter the traction battery pack 18 through an inlet 44 and may exit the traction battery pack 18 through an outlet 46 prior to eventually being returned to the inlet 42 of the heat exchanger 34. Thermal energy contained within the coolant C may be rejected to atmosphere at the heat exchanger 34.

The gas separator 38 may be located between the outlet 46 of the traction battery pack 18 and the inlet 42 of the heat exchanger 34. In an embodiment, the gas separator 38 is located between the outlet 46 and the pump 36. However, other locations are possible within the scope of this disclosure.

The gas separator 38 may be configured to deaerate the coolant C as it is circulated through the coolant circuit 32. Removing entrained gases G (e.g., air, etc.) from the coolant C can be important for providing proper circulation of the coolant C through the coolant circuit 32 during normal operating conditions of the traction battery pack 18, for example. The coolant C may enter the gas separator 38 at a low point, undergo a spinning or cyclonic motion, and then exit a high point of the gas separator 38 to cause the gas G to separate from the coolant C.

The gas separator 38 may be fluidly connected to the reservoir 40 by a gas line 50. The reservoir 40 includes an interior area 52 that can hold a supply 54 of the coolant C. Coolant C from the supply 54 may be gravity fed through a fill line 56 to an inlet side 58 of the pump 36. The coolant C received from the fill line 56 of the reservoir 40 may provide a sufficient pressure on the inlet side 58 of the pump 36 for reducing the likelihood of pump cavitation.

The interior area 52 of the reservoir 40 may further includes a gas region 60, which can receive the gases G deaerated from the coolant C of the coolant circuit 32. As the gas G is removed from the coolant circuit 32 by the gas separator 38 during normal operating traction battery conditions, the gas G can move vertically upward from the gas separator 38, through the gas line 50, and enter the gas region 60 of the reservoir 40. The gas G received within the gas region 60 may subsequently be expelled to atmosphere. The volume of the coolant circuit 32 previously occupied by the gas G can then be replaced with coolant C from the supply 54 via fill line 56.

As is schematically illustrated in FIG. 2, one or more of the battery cells 24 packaged within the traction battery pack 18 can periodically release vent byproducts V during a battery thermal event. A battery thermal event may occur, for example, during an overcharge condition, an overdischarging condition, a short circuit, etc. The vent byproducts V can be released from the battery cells 24 through a vent and can include both gases and effluent particles. Pressure increases within one of the battery cells 24 can cause the vent to rupture, thereby creating a path for the vent byproducts V to be released from inside the battery cell 24 into the interior area 26 of the traction battery pack 18 during the battery thermal event.

The gas separator 38 may be configured to remove the gases and other effluents associated with the vent byproducts V from the coolant C during the battery thermal event. The vent byproducts V removed by the gas separator 38 may be delivered to the gas region 60 of the reservoir 40 through the gas line 50. The vent byproducts V received within the gas region 60 may subsequently be expelled to atmosphere, thereby quickly and efficiently expelling the vent byproducts V from the thermal management system 30 and reducing or even eliminating convective heat transfer across the coolant circuit 32 that could be caused by the vent byproducts V during the battery thermal event.

The gas separator 38 may be packaged at a first location L1 of the electrified vehicle 10, and the reservoir 40 may be packaged at a second location L2 of the electrified vehicle 10. In an embodiment, the second location L2 is vertically higher than the first location L1. The second location L2 may be the vertically highest point of the coolant circuit 32, for example. Vertical, for purposes of this disclosure, are with reference to ground in the ordinary orientation of the electrified vehicle 10 during its operation.

A relatively large amount of vent byproducts V could be released from the traction battery pack 18 into the coolant circuit 32 during the battery thermal event. In some instances, the volume of the vent byproducts V could be large enough that the gas separator 38 is incapable of efficiently removing the gases and other effluents associated with the vent byproducts V from the coolant C during the battery thermal event. The thermal management system 30 may therefore additionally include a pressure relief valve 62 that can selectively open an auxiliary fluid path 64 for delivering at least a portion of the vent byproducts V and the coolant C exiting the traction battery pack 18 to the reservoir 40 during the battery thermal event. The portion of the vent byproducts V and the coolant C communicated through the auxiliary fluid path 64 may bypass the gas separator 38, thus reducing its degassing burden during the battery thermal event.

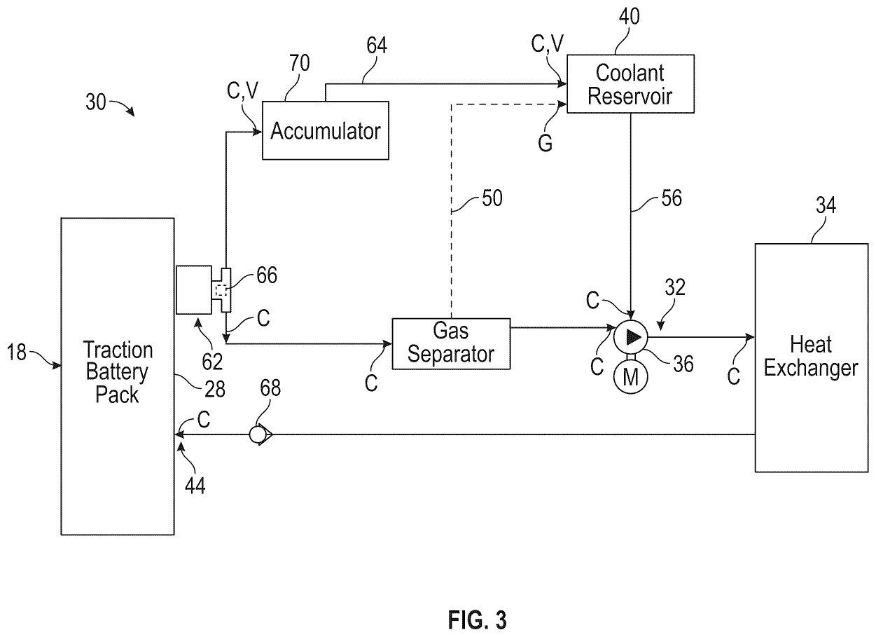

The pressure relief valve 62 may be fluidly connected to the outlet 46 of the traction battery pack 18 and may be located upstream from the gas separator 38 within the coolant circuit 32. In an embodiment, pressure relief valve 62 is located downstream from the traction battery pack 18 (see, e.g., FIG. 2). In another embodiment, the pressure relief valve 62 is mounted directly to the enclosure assembly 28 of the traction battery pack 18 (see, e.g., FIG. 3).

The pressure relief valve 62 may include a valve member 66 (shown schematically) that is arranged inside the pressure relief valve 62 and configured for controlling the flow of fluid permitted to enter into the auxiliary fluid path 64. The valve member 66 may be movable between a default closed position and a secondary actuated position to control fluid flow into the auxiliary fluid path 64. In an embodiment, the valve member 66 is a ball valve that is biased into the default closed position by a biasing member (not shown). However, other valve members, including but not limited prismatic valves, poppet valves, etc., could be employed for use within the pressure relief valve 62 within the scope of this disclosure.

The valve member 66 of the pressure relief valve 62 may be configured to transition from the default closed position to the secondary actuated position when a pressure of the fluid (e.g., both coolant C and vent byproducts V) exiting the outlet 46 of the traction battery pack 18 exceeds a predefined pressure threshold due to one or more of the battery cells 24 venting during the battery thermal event. When in the default closed position, the valve member 66 of the pressure relief valve 62 blocks the fluid from entering the auxiliary fluid path 64. When moved to the secondary actuated position, the fluid is permitted to enter the auxiliary fluid path 64 for subsequent delivery into the reservoir 40 simultaneously with the portion of the fluid being delivered to the reservoir 40 through the gas line 50.

Communicating the fluid to the reservoir 40 through both the gas line 50 and the auxiliary fluid path 64 during the battery thermal event allows for the rapid removal of gases and other effluents generated during the event, thereby reducing overall system pressure without overwhelming the gas separator 38. Notably, during normal operating conditions, the auxiliary fluid path 64 remains closed and thus all fluid flow exiting the outlet 46 of the traction battery pack 18 passes through the gas separator 38.

The thermal management system 30 may additionally include a check valve 68. The check valve 68 may be positioned within the coolant circuit 32 at a location that is between the heat exchanger 34 and the inlet 44 of the traction battery pack 18, for example. The check valve 68 may be configured to prevent the coolant C from flowing back in a direction toward the heat exchanger 34 and the pump 36 during certain operating conditions, thereby substantially reducing the likelihood of experiencing pump cavitation.

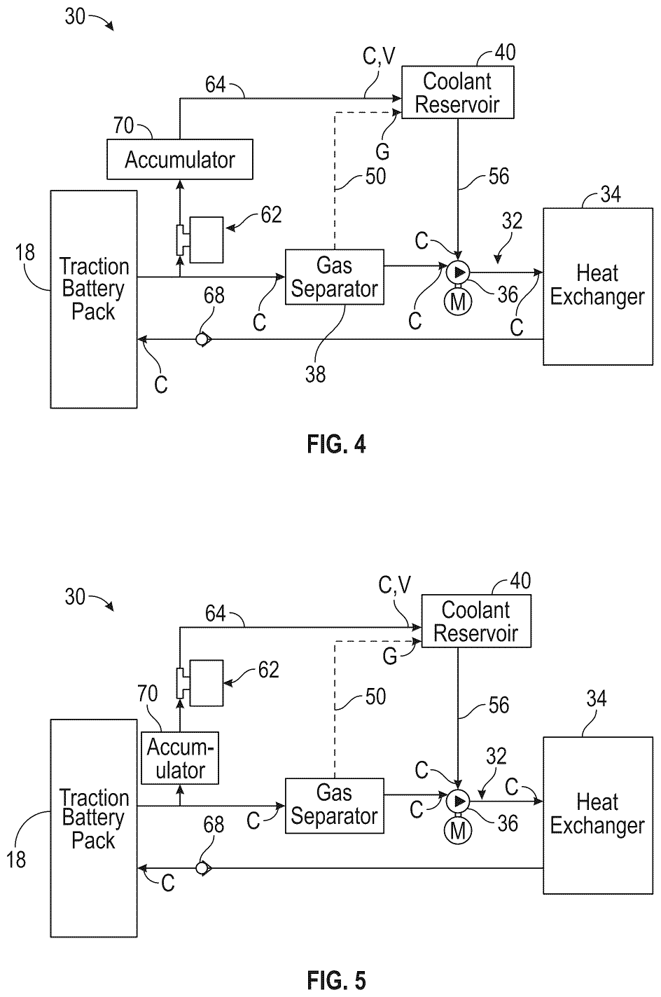

The thermal management system 30 may, in some implementations, include an accumulator 70 (see, e.g., FIGS. 3, 4, and 5). The accumulator 70 may be provided to slow the volume of fluid (e.g., both coolant C and vent byproducts V) that can be delivered to the reservoir 40 through the auxiliary fluid path 64 during the battery thermal event, thereby reducing the gas expulsion rate required at the reservoir 40. The accumulator 70 may be in fluid communication with the pressure relief valve 62 and may be positioned either downstream from the pressure relief valve 62 (see FIGS. 3 and 4) or upstream from the pressure relief valve 62 (see FIG. 5).

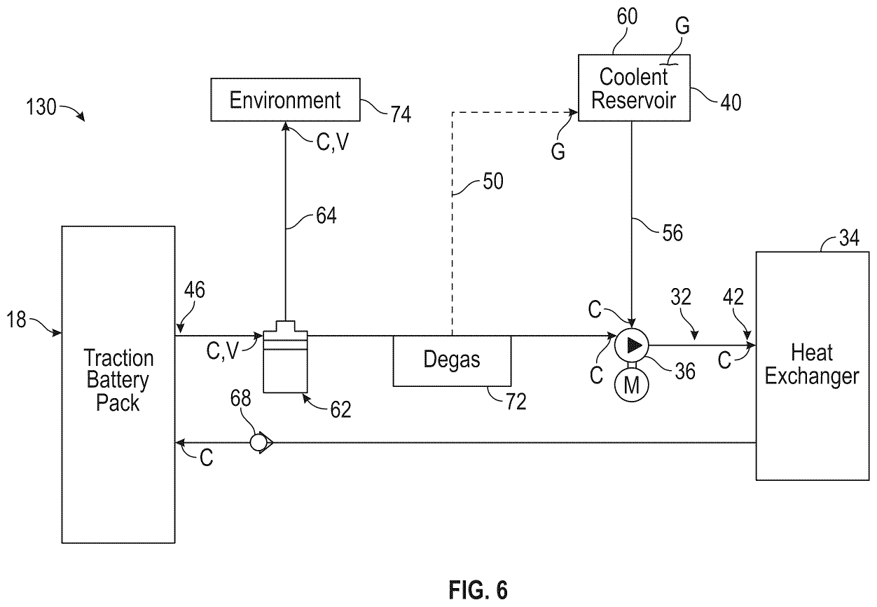

FIG. 6 schematically illustrates another exemplary thermal management system 130 for an electrified vehicle. The thermal management system 130 is similar to the thermal management system 30 of FIG. 2 and includes many of the same or similar subcomponents. However, in this embodiment, the gas separator 38 is replaced by a degas bottle 72. The degas bottle 72 may be located between the outlet 46 of the traction battery pack 18 and the inlet 42 of the heat exchanger 34 and may be configured to allow entrained air and gasses in the coolant C to be separated from the coolant C as it flows through the degas bottle 72. The gas G removed from the coolant C can move vertically through the gas line 50 and enter the gas region 60 of the reservoir 40 for subsequent discharge to atmosphere.

Like the thermal management system 30, the thermal management system 130 may include the pressure relief valve 62 for controlling fluid flow into the auxiliary fluid path 64. However, in this embodiment, rather than the auxiliary fluid path 64 delivering portions of the vent byproducts V and the coolant C exiting the traction battery pack 18 during the battery thermal event to the reservoir 40, the fluid may instead be delivered directly to atmosphere 74.

The exemplary thermal management systems of this disclosure incorporate a gas separator or degas bottle, a reservoir, and a pressure relief valve that can be utilized for removing and expelling gases from a coolant circuit of the system. The proposed systems are capable of removing gases from the coolant during both normal operating conditions and during battery thermal events that require increased coolant volume and flow rates for mitigating convective heat transfer. The inclusion of the pressure relief valve allows for expelling fluid through an auxiliary fluid path for rapidly removing the gases and effluents generated during battery thermal events and reducing overall system pressures while reducing the removal burden of the gas separator or degas bottle.

In this disclosure, the term “about” means that the expressed quantities or ranges need not be exact but may be approximated and/or larger or smaller, reflecting acceptable tolerances, conversion factors, measurement error, etc.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A thermal management system for an electrified vehicle, comprising:
a traction battery pack;
a coolant circuit configured to circulate a coolant through the traction battery pack;
an auxiliary fluid path fluidly connectable to the coolant circuit; and
a pressure relief valve configured to control a flow of a vent byproduct released by a battery cell of the traction battery pack into the auxiliary fluid path during a battery thermal event of the traction battery pack.

2. The thermal management system as recited in claim 1, wherein the thermal management system is an immersion thermal management system.

3. The thermal management system as recited in claim 1, wherein the pressure relief valve includes a valve member movable from a default closed position in which the vent byproduct is prevented from entering the auxiliary fluid path to a secondary actuated position in which the vent byproduct is permitted to enter the auxiliary fluid path.

4. The thermal management system as recited in claim 3, wherein the valve member is configured to move from the default closed position to the secondary actuated position when a pressure of the vent byproduct received at the pressure relief valve exceeds a predefined pressure threshold.

5. The thermal management system as recited in claim 1, comprising a gas separator configured to deaerate the coolant that is circulated through the traction battery pack.

6. The thermal management system as recited in claim 5, comprising a reservoir configured to receive a gas removed from the coolant by the gas separator.

7. The thermal management system as recited in claim 6, wherein the gas separator is packaged at a first location of the electrified vehicle, and the reservoir is packaged at a second location of the electrified vehicle, and further wherein the second location is vertically higher than the first location.

8. The thermal management system as recited in claim 7, wherein the second location is at a highest point of the coolant circuit.

9. The thermal management system as recited in claim 6, wherein the gas includes a portion of the vent byproduct released by the battery cell of the traction battery pack.

10. The thermal management system as recited in claim 1, comprising a heat exchanger configured to cool the coolant prior to the coolant being returned to the traction battery pack.

11. The thermal management system as recited in claim 10, comprising a check valve arranged within the coolant circuit between the heat exchanger and the traction battery pack.

12. The thermal management system as recited in claim 1, wherein the auxiliary fluid path is fluidly connected to a coolant reservoir.

13. The thermal management system as recited in claim 1, wherein the auxiliary fluid path is fluidly connected to atmosphere.

14. The thermal management system as recited in claim 1, comprising an accumulator positioned either upstream or downstream from the pressure relief valve.

15. A thermal management system for an electrified vehicle, comprising:
a traction battery pack;
a gas separator configured to deaerate a coolant that is circulated through the traction battery pack;
a reservoir configured to receive a gas once removed from the coolant by the gas separator; and
a pressure relief valve configured to control a flow of a vent byproduct released by a battery cell of the traction battery pack into an auxiliary fluid path that bypasses the gas separator during a battery thermal event of the traction battery pack.

16. The thermal management system as recited in claim 15, comprising an accumulator positioned either upstream or downstream from the pressure relief valve.

17. The thermal management system as recited in claim 15, wherein the pressure relief valve includes a valve member movable from a default closed position in which the vent byproduct is prevented from entering the auxiliary fluid path to a secondary actuated position in which the vent byproduct is permitted to enter the auxiliary fluid path.

18. The thermal management system as recited in claim 17, wherein the valve member is configured to move from the default closed position to the secondary actuated position when a pressure of the vent byproduct received at the pressure relief valve exceeds a predefined pressure threshold.

19. The thermal management system as recited in claim 15, wherein the auxiliary fluid path is fluidly connected to the reservoir.

20. The thermal management system as recited in claim 15, comprising a check valve located between the traction battery pack and a heat exchanger that is configured to exchange heat with the coolant.
